(19) United States
(12) Patent Application Publication
(10) Pub. No.: US 2012/0050490 A1
(43) Pub. Date: Mar. 1, 2012

(54) METHOD AND SYSTEM FOR DEPTH-INFORMATION BASED AUTO-FOCUSING FOR A MONOSCOPIC VIDEO CAMERA

(76) Inventors: Xuemin Chen, Rancho Santa Fe, CA (US); Nambi Seshadri, Irvine, CA (US); Jeyhan Karaoguz, Irvine, CA (US); Chris Boross, Sunnyvale, CA (US)

(21) Appl. No.: 13/077,923

(22) Filed: Mar. 31, 2011

Related U.S. Application Data
(60) Provisional application No. 61/377,867, filed on Aug. 27, 2010.
(60) Provisional application No. 61/439,297, filed on Feb. 3, 2011.

(51) Int. Cl. H04N 13/02

(52) U.S. Cl. 348/47; 348/E13.074

(57) ABSTRACT

A monoscopic video camera array concurrently captures a 2D image and corresponding depth information. A region of interest (ROI) within the captured 2D image is selected as a focal point based on the captured corresponding depth information and associated lighting conditions for focusing the captured 2D image. A focal length is selected based on the captured corresponding depth information and the associated lighting conditions within the selected ROI so as to adjust YCrCb information, accordingly. The captured 2D image together with the adjusted YCrCb information may be focused for display. Auto-focusing process may be performed in multi-steps. A range and a step size of focal lengths may be determined based on the captured corresponding depth information, and associated lighting conditions, processing capabilities of the monoscopic video camera array, and/or use inputs. The auto-focusing process may be repeated step-by-step for a high quality focused image.

### CROSS-REFERENCE TO RELATED APPLICATIONS/INCORPORATION BY REFERENCE

This patent application makes reference to, claims priority to, and claims benefit from U.S. Provisional Application Ser. No. 61/377,867, which was filed on Aug. 27, 2010.

This patent application makes reference to, claims priority to, and claims benefit from U.S. Provisional Application Ser. No. 61/439,297, which was filed on Feb. 3, 2011.

This application also makes reference to:
U.S. Patent Application Ser. No. 61/439,193 filed on Feb. 3, 2011;
U.S. patent application Ser. No. ______ (Attorney Docket No. 23461US03) filed on Mar. 31, 2011;
U.S. Patent Application Ser. No. 61/439,274 filed on Feb. 3, 2011;
U.S. patent application Ser. No. ______ (Attorney Docket No. 23462US03) filed on Mar. 31, 2011;
U.S. Patent Application Ser. No. 61/439,283 filed on Feb. 3, 2011;
U.S. patent application Ser. No. ______ (Attorney Docket No. 23463US03) filed on Mar. 31, 2011;
U.S. Patent Application Ser. No. 61/439,130 filed on Feb. 3, 2011;
U.S. patent application Ser. No. ______ (Attorney Docket No. 23464US03) filed on Mar. 31, 2011;
U.S. Patent Application Ser. No. 61/439,290 filed on Feb. 3, 2011;
U.S. patent application Ser. No. ______ (Attorney Docket No. 23465US03) filed on Mar. 31, 2011;
U.S. Patent Application Ser. No. 61/439,119 filed on Feb. 3, 2011;
U.S. patent application Ser. No. ______ (Attorney Docket No. 23466US03) filed on Mar. 31, 2011;
U.S. Patent Application Ser. No. 61/439,297 filed on Feb. 3, 2011;
U.S. patent application Ser. No. ______ (Attorney Docket No. 23467US03) filed on Mar. 31, 2011;
U.S. Patent Application Ser. No. 61/439,201 filed on Feb. 3, 2011;
U.S. Patent Application Ser. No. 61/439,209 filed on Feb. 3, 2011;
U.S. Patent Application Ser. No. 61/439,113 filed on Feb. 3, 2011;
U.S. patent application Ser. No. ______ (Attorney Docket No. 23472US03) filed on Mar. 31, 2011;
U.S. Patent Application Ser. No. 61/439,103 filed on Feb. 3, 2011;
U.S. patent application Ser. No. ______ (Attorney Docket No. 23473US03) filed on Mar. 31, 2011;
U.S. Patent Application Ser. No. 61/439,083 filed on Feb. 3, 2011;
U.S. patent application Ser. No. ______ (Attorney Docket No. 23474US03) filed on Mar. 31, 2011;
U.S. Patent Application Ser. No. 61/439,301 filed on Feb. 3, 2011; and
U.S. patent application Ser. No. ______ (Attorney Docket No. 23475US03) filed on Mar. 31, 2011.

Each of the above stated applications is hereby incorporated herein by reference in its entirety.

### FIELD OF THE INVENTION

Certain embodiments of the invention relate to video processing. More specifically, certain embodiments of the invention relate to a method and system for depth-information based auto-focusing for a monoscopic video camera.

### BACKGROUND OF THE INVENTION

Digital video capabilities may be incorporated into a wide range of devices such as, for example, digital televisions, digital direct broadcast systems, digital recording devices, and the like. Digital video devices may provide significant improvements over conventional analog video systems in processing and transmitting video sequences with increased bandwidth efficiency.

Video content may be recorded in two-dimensional (2D) format or in three-dimensional (3D) format. In various applications such as, for example, the DVD movies and the digital TV, a 3D video is often desirable because it is often more realistic to viewers than the 2D counterpart. A 3D video comprises a left view video and a right view video. A 3D video frame may be produced by combining left view video components and right view video components, respectively.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for depth-information based auto-focusing for a monoscopic video camera, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary video communication system that is operable to support auto-focusing for a monoscopic video camera utilizing depth information, in accordance with an embodiment of the invention.

FIG. 2 illustrates mapping of 2D image data to different image planes depending on corresponding depth information, in accordance with an embodiment of the invention.

FIG. 3 illustrates auto-focusing of 2D monoscopic images utilizing corresponding depth information, in accordance with an embodiment of the invention.

FIG. 4 is a flow chart illustrating exemplary steps that may be performed for auto-focusing in a monoscopic video camera utilizing depth information, in accordance with an embodiment of the invention.

FIG. 5 is a flow chart illustrating exemplary steps that may be performed for multi-step auto-focusing in a monoscopic video camera utilizing depth information, in accordance with an embodiment of the invention.

### DETAILED DESCRIPTION OF THE INVENTION

Certain embodiments of the invention may be found in a method and system for depth-information based auto-focusing for a monoscopic video camera. In various embodiments of the invention, a monoscopic video camera array comprises one or more image sensors and one or more depth sensors. Each associated monoscopic video camera of the monoscopic video camera array is operable to concurrently capture a two-dimensional (2D) monoscopic image and corresponding depth information. A region of interest within the captured 2D monoscopic image may be selected as a focal point based on the captured corresponding depth information and associated lighting conditions for focusing the captured 2D monoscopic image. The monoscopic video camera may automatically focus the captured 2D monoscopic image utilizing the captured corresponding depth information and the associated lighting conditions within the selected region of interest. In this regard, the focal length for the monoscopic video camera array may be selected based on the captured corresponding depth information and the associated lighting conditions within the selected region of interest, and/or through interacting with users. Luminance, chrominance red and chrominance blue (YCrCb) information for the captured 2D monoscopic image may be adjusted based on the selected focal length. The captured 2D monoscopic image together with the adjusted YCrCb information may be focused for display. Depending on system configuration, the monoscopic video camera array may perform auto-focusing in multi-steps. In this regard, a range of focal lengths for the monoscopic video camera array may be determined based on the captured corresponding depth information and the associated lighting conditions within the selected region of interest and/or processing capabilities such as motion detection of the monoscopic video camera array. A step size for multi-step auto-focusing may be selected based on the determined range of focal lengths, the processing capabilities of the monoscopic video camera, a mobility state of one or more objects within the selected region of interest, and/or user inputs or preferences. The auto-focusing process may be repeated step-by-step for a high quality focused image.

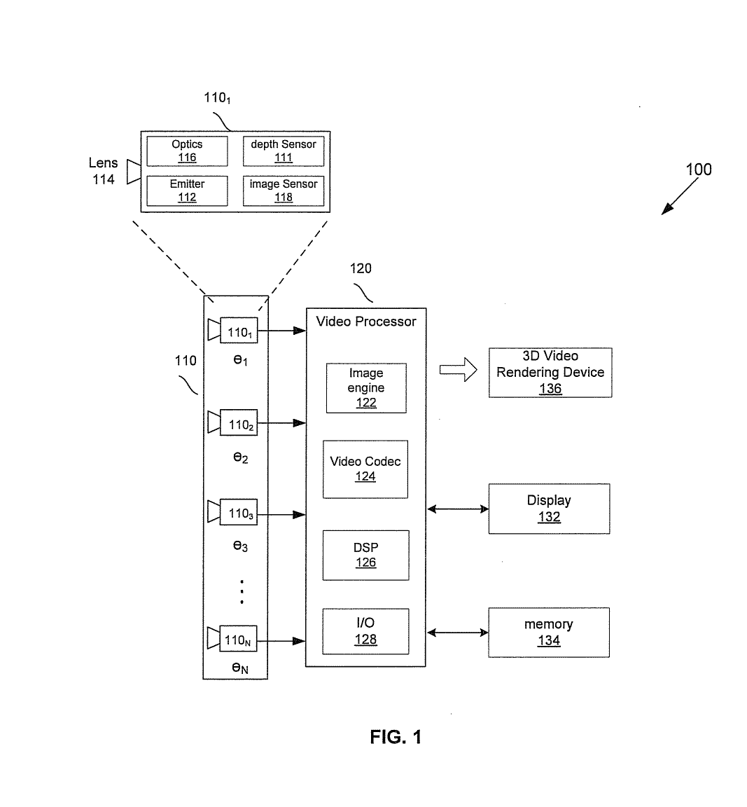

FIG. 1 is a diagram illustrating an exemplary video communication system that is operable to support auto-focusing for a monoscopic video camera utilizing depth information, in accordance with an embodiment of the invention. Referring to FIG. 1, there is shown a video communication system 100. The video communication system 100 comprises a monoscopic video camera array 110, a video processor 120, a display 132, a memory 134 and a 3D video rendering device 136.

The monoscopic video camera array 110 may comprise a plurality of single-viewpoint or monoscopic video cameras 110₁-110_{N}, where the parameter N is the number of monoscopic video cameras. Each of the monoscopic video cameras 110₁-110_{N} may be placed at a certain view angle with respect to a target scene in front of the monoscopic video camera array 110. Each of the monoscopic video cameras 110₁-110_{N} may operate independently to collect or capture information for the target scene. The monoscopic video cameras 110₁-110_{N} each may be operable to capture 2D image data and corresponding depth information for the target scene. A 2D video comprises a collection of 2D sequential images. 2D image data for the 2D video specifies intensity and/or color information in terms of pixel position in the 2D sequential images. Depth information for the 2D video represents distance to objects visible in terms of pixel position in the 2D sequential images. The monoscopic video camera array 110 may provide or communicate the captured image data and the captured corresponding depth information to the video processor 120 for further process to support 2D and/or 3D video rendering and/or playback, for example.

A monoscopic video camera such as the monoscopic video camera 110₁ may comprise a depth sensor 111, an emitter 112, a lens 114, optics 116, and one or more image sensors 118. The monoscopic video camera 110₁ may comprise suitable logic, circuitry, interfaces, and/or code that may be operable to capture a 2D monoscopic image via a single viewpoint corresponding to the lens 114. The monoscopic video camera 110₁ may be operable to collect corresponding depth information for the captured 2D image via the depth sensor 111. The monoscopic video camera 110₁ may manage or control the lens 114 and the image sensor(s) 118 to capture high quality images for a target scene without user intervention or knowledge about controlling exposure and/or focus. For example, the monoscopic video camera 110₁ may automatically zoom to objects of interest in the target scene. In this regard, the monoscopic video camera 110₁ may be operable to adjust the lens 114 for the sharpest possible image on the target scene.

The depth sensor 111 may comprise suitable logic, circuitry, interfaces, and/or code that may be operable to detect electromagnetic (EM) waves in the infrared spectrum. The depth sensor 111 may determine or detect depth information for the objects in the target scene based on corresponding infrared EM waves. For example, the depth sensor 111 may sense or capture depth information for the objects in the target scene based on time-of-flight of infrared EM waves transmitted by the emitter 112 and reflected from the objects back to the depth sensor 111.

The emitter 112 may comprise suitable logic, circuitry, interfaces, and/or code that may be operable to produce and/or transmit electromagnetic waves in infrared spectrum, for example.

The lens 114 is an optical component that may be utilized to capture or sense EM waves passing through an aperture of the lens 114. The aperture is referred to the lens diaphragm opening inside the lens 114. The size of the aperture of the lens 114 may control the amount of EM waves captured during an exposure process. The captured EM waves in the visible spectrum may be focused through the optics 116 on the image sensor(s) 118 to form or captured 2D images for the target scene. The captured EM waves in the infrared spectrum may be focused through the optics 116 on the depth sensor 111 to capture corresponding depth information for the captured 2D images. The captured corresponding depth information for the captured 2D images may have a direct relation with factors on the lens 114. For example, the performance of the lens 114 may be governed by the size aperture of the lens 114, the image size and the focal length of the lens 114. The focal length for the lens 114 is referred to as the distance between the lens 114 and a focal point for objects of interest in the target scene, which may in turn reflect or indicate depth information captured or measured for the objects in the target scene. In this regard, the captured depth information for the objects in the target scene may be utilized to adjust the focal length for the lens 114 for auto-focusing.

It may be assumed that within a depth image, deeper or darker or high depth value regions represent that the corresponding objects are far away from the user and shallower or lighter or low depth value regions indicate that the corresponding objects are closer to the user. If the image size and the aperture remain the same on the lens 114, depth information captured with the shorter focal length may correspond to the shallower regions or areas for the objects in the target scene. In other words, with the shorter focal length applied to the lens 114, the captured depth information may indicate or represent that the objects in the target scene are closer to the user. For example, comparing a 28 mm lens with a 50 mm lens at the same aperture and image size, the depth information captured via the 28 mm lens may indicate a shallower region or area for the objects in the target scene.

The focal length for the lens 114 may affect the degree of detail blur within the 2D images captured via the image sensor(s) 118. In this regard, the focal length may vary in order to obtain a focused image as the objects in the target scene move around. A focused image may comprise more high frequency components than a corresponding defocused or blurred image. In this regard, the contrast in the focused image may be higher than in the same defocused or blurred image.

The optics 116 may comprise optical devices for conditioning and directing EM waves received via the lens 114. The optics 116 may direct the received EM waves in the visible spectrum to the image sensor(s) 118 and direct the received EM waves in the infrared spectrum to the depth sensor 111, respectively. The optics 116 may comprise one or more lenses, prisms, luminance and/or color filters, and/or mirrors.

The image sensor(s) 118 may each comprise suitable logic, circuitry, interfaces, and/or code that may be operable to sense optical signals focused by the lens 114. The image sensor(s) 118 may convert the optical signals to electrical signals so as to capture intensity and/or color information forming image raw data for the target scene. In this regard, the image sensor(s) 118 may provide the captured image raw data to the video processor 120. The provided image raw data may be transformed by the video processor 120 into the YCrCb color space for internal representation within the monoscopic video cameras 110₁, for example. Each image sensor 118 may comprise, for example, a charge coupled device (CCD) image sensor or a complimentary metal oxide semiconductor (CMOS) image sensor.

The video processor 120 may comprise suitable logic, circuitry, interfaces, and/or code that may be operable to handle and control operations of various device components such as the monoscopic video camera array 110, and manage output to the display 132 and/or the 3D video rendering device 136. The video processor 120 may comprise an image engine 122, a video codec 124, a digital signal processor (DSP) 126 and an input/output (I/O) 128. The video processor 120 may utilize the image sensors 118 to capture 2D monoscopic image (raw) data. The video processor 120 may utilize the depth sensor 111 to collect corresponding depth information for the captured 2D monoscopic image data. The video processor 120 may process the captured 2D monoscopic image data and the captured corresponding depth information via the image engine 122 and the video codec 124, for example. In this regard, the video processor 120 may be operable to transform or convert the 2D image (raw) data from the image sensor(s) 118 into the YCrCb color space. In an exemplary embodiment of the invention, the video processor 120 may set or adjust YCrCb information for the resulting image data in the YCrCb space utilizing corresponding depth information for the captured 2D image data from the image sensor(s) 118 in the monoscopic video cameras 110₁. The video processor 120 may be operable to compose a 2D and/or 3D image from the processed 2D image data and the processed corresponding depth information for 2D and/or 3D video rendering and/or playback. The composed 2D and/or 3D image may be presented or displayed to a user via the display 132 and/or the 3D video rendering device 136. The video processor 120 may also be operable to enable or allow a user to interact with the monoscopic video camera array 110, when needed, to support or control image recording and/or playback.

In an exemplary embodiment of the invention, the video processor 120 may be operable to track and evaluate the image quality such as the degree of blur within the composed 2D and/or 3D image. In some circumstances, the degree of blurr in the composed 2D and/or 3D image is too high and may not be satisfactory to the user, the video processor 120 may instruct the monoscopic video cameras 110₁ to continue capturing and focusing process for a better focused image.

The image engine 122 may comprise suitable logic, circuitry, interfaces, and/or code that may be operable to receive 2D image data captured via the monoscopic video cameras 110₁-110_{N} and provide or output view-angle dependent 2D image data and corresponding view-angle dependent depth information, respectively. In this regard, the image engine 122 may model or map 2D monoscopic image data and corresponding depth information, captured by the monoscopic video camera array 110, to an image mapping function in terms of view angles and lighting condition changes. The image mapping function may convert the captured 2D monoscopic image data and the captured corresponding depth information to different set of 2D image data and corresponding depth information depending on view angles and lighting condition changes. The image mapping function may be determined, for example, by matching or fitting the captured 2D monoscopic image data and the captured corresponding depth information to known view angles and lighting condition changes of the monoscopic video cameras 110₁-110_{N}. The image engine 122 may utilize the determined image mapping function to map or convert the captured monoscopic image data and the captured corresponding depth information to view-angle dependent 2D image data and view-angle dependent depth information, respectively.

The video codec 124 may comprise suitable logic, circuitry, interfaces, and/or code that may be operable to perform video compression and/or decompression. The video codec 124 may utilize various video compression and/or decompression algorithms such as video compression and/or decompression algorithms specified in MPEG-2, and/or other video formats for video coding.

The DSP 126 may comprise suitable logic, circuitry, interfaces, and/or code that may be operable to perform signal processing of image data and depth information supplied from the monoscopic video camera array 110.

The I/O module 128 may comprise suitable logic, circuitry, interfaces, and/or code that may enable the monoscopic video camera array 110 to interface with other devices in accordance with one or more standards such as USB, PCI-X, IEEE 1394, HDMI, DisplayPort, and/or analog audio and/or analog video standards. For example, the I/O module 128 may be operable to communicate with the image engine 122 and the video codec 124 for a 2D and/or 3D image for a given user's view angle, output the resulting 2D and/or 3D image, read from and write to cassettes, flash cards, or other external memory attached to the video processor 120, and/or output video externally via one or more ports such as a IEEE 1394 port, a HDMI and/or an USB port for transmission and/or rendering.

The display 132 may comprise suitable logic, circuitry, interfaces, and/or code that may be operable to display images to a user. The display 132 may comprise a liquid crystal display (LCD), a light emitting diode (LED) display and/or other display technologies on which images captured via the monoscopic video camera array 110 may be displayed to the user at a given user's view angle.

The memory 134 may comprise suitable logic, circuitry, interfaces and/or code that may be operable to store information such as executable instructions and data that may be utilized by the monoscopic video camera array 110. The executable instructions may comprise various video compression and/or decompression algorithms utilized by the video codec 124 for video coding. The data may comprise captured images and/or coded video. The memory 134 may comprise RAM, ROM, low latency nonvolatile memory such as flash memory and/or other suitable electronic data storage.

The 3D video rendering device 136 may comprise suitable logic, circuitry, interfaces, and/or code that may be operable to render images supplied from the monoscopic video camera array 110. The 3D video rendering device 136 may be coupled to the video processor 120 internally or externally. The 3D video rendering device 136 may be adapted to different user's view angles and lighting condition changes to render 3D video output from the video processor, 120.

Although the monoscopic video camera array 110 is illustrated in FIG. 1 to support depth-information based auto-focusing, the invention is not so limited. In this regard, an array of monoscopic video sensing devices, which comprises one or more image sensors and one or more depth sensors, may be utilized to support depth-information based auto-focusing without departing from the spirit and scope of the various embodiments of the invention. An image sensor may comprise one or more light emitters and/or one or more light receivers.

In an exemplary operation, the monoscopic video camera array 110 may be operable to concurrently or simultaneously capture a plurality of 2D monoscopic images and corresponding depth information. The monoscopic video camera array 110 may manage or control each of the monoscopic video cameras 110₁-110_{N} to perform auto-focusing in order to capture high quality images for the target scene. For example, the monoscopic video camera 110₁ may be operable to track objects of interest in the target scene. The focal length may be selected for the lens 114 so that the monoscopic video camera 110₁ may be zoomed to the objects in the target scene. The focal length of the lens 114 may be selected and adjusted for the sharpest possible images on the target scene.

In an exemplary embodiment of the invention, the monoscopic video camera 110₁ may be operable to automatically focus captured 2D monoscopic images utilizing the captured corresponding depth information. In this regard, depending on image quality such as the degree of detail blur in the captured images, the monoscopic video camera 110₁ may be operable to select and/or adjust the focal length for the lens 114 based on the captured corresponding depth information for the captured 2D monoscopic images. For example, during image auto-focusing, the monoscopic video camera 110₁ may be operable to decrease the focal length for the lens 114 with decreasing of the captured corresponding depth information for the captured 2D monoscopic images. Similarly, the monoscopic video camera 110₁ may increase the focal length for the lens 114 with increasing of the captured corresponding depth information for the captured 2D monoscopic images.

In an exemplary embodiment of the invention, the monoscopic video camera 110₁ may be operable to provide the captured 2D monoscopic images to the video processor 120 for depth-information based luminance, chrominance red and chrominance blue (YCrCb) process. In this regard, the video processor 120 may be operable to adjust luminance, chrominance red and chrominance blue (YCrCb) information for the captured 2D monoscopic images utilizing the captured corresponding depth information. In this regard, depending on the degree of detail blur in the captured 2D images, the video processor 120 may be operable to set and/or adjust the YCrCb information based on the captured corresponding depth information for the captured 2D monoscopic images. For example, during auto-focusing, the video processor 120 may increase or enhance R color value and decrease G color value with increasing of the captured corresponding depth information for the captured 2D monoscopic images.

In an exemplary embodiment of the invention, the video processor 120 may manage and control the monoscopic video camera 110₁ to incorporate the depth-based auto-focusing with processing capabilities of the video processor 120 and the monoscopic video camera 110₁. In this regard, the monoscopic video camera 110₁ may select or determine the range of focal lengths allowed for the lens 114 based on the processing capabilities such as motion detection, target tracking, shading correction and tone set, color interpolation and/or auto exposure control. For example, the range of focal lengths for the lens 114 may be selected depending on how fast the video processor 120 may be able to detect and track moving targets in the captured 2D monoscopic images. The focal length for the lens 114 may be adjusted based on the determined range of focal lengths to focus the monoscopic video camera 110₁ to the objects in the target scene. The range of focal lengths for the lens 114 may be also selected depending on user inputs through interacting with users.

In an exemplary embodiment of the invention, the monoscopic video camera 110₁ may be operable to perform one-step or multi-step focal length adjustment based on the captured depth information and accepted image quality. The one-step focal length adjustment may comprise focal length adjustment based on the overall variation in the captured depth information. The multi-step focal length adjustment may smooth out the overall variation over the captured depth information to gradually, step-by-step, adjusting the focal length for the lens 114. In this regard, a focal length step size for auto-focusing may be determined based on the processing capabilities and/or the mobility state of the objects in the target scene. The mobility state of the objects may comprise mobility information of the objects, for example, how fast or how slow the objects move. In this regard, a decreased focal length step size may be utilized or applied if the objects in the target scene move slowly. In some circumstances, the objects in the target scene move fast. The focal length step size may be increased accordingly. The process may be repeated for the sharpest possible images. The focal length step size may be also selected depending on user inputs through interacting with users.

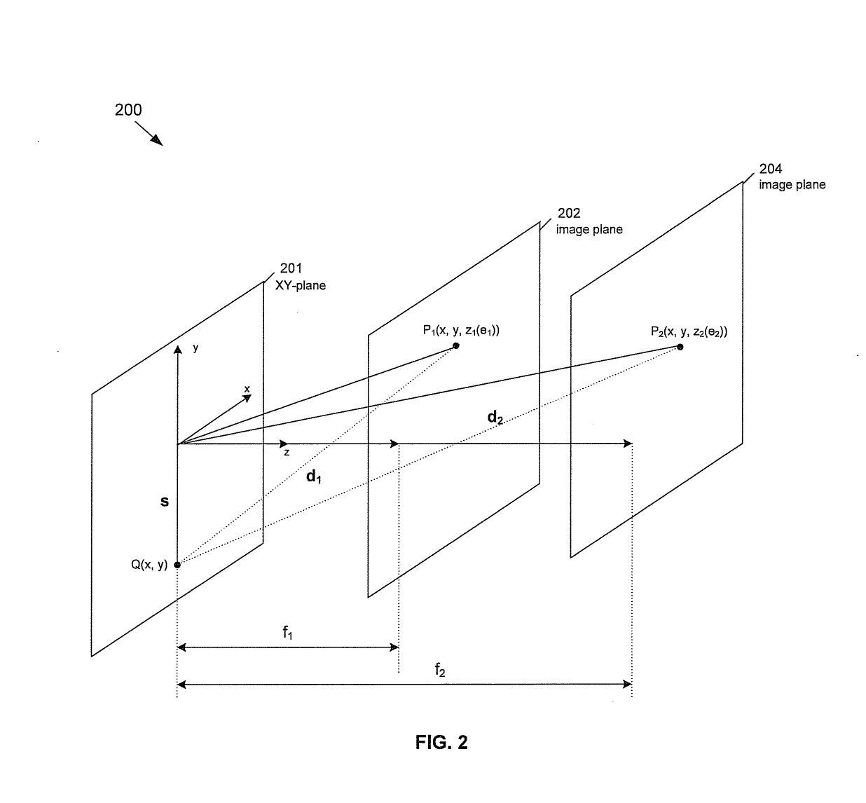

FIG. 2 illustrates mapping of 2D image data to different image planes depending on corresponding depth information, in accordance with an embodiment of the invention. Referring to FIG. 2, there is shown a XYZ coordinate system 200. The XYZ coordinate system 200 comprises a XY-plane 201 and image planes 202-204. An image plane may be assumed to be coincident with the XY-plane of a XYZ coordinate system, and is parallel to the XY-plane at distance z, where z>0. The video processor 120 may be operable to interpret an image pixel such as a point Q(x,y) in the XY-plane 201 in different image planes, in space, depending on corresponding depth information for the image pixel. For example, assume that the parameters f₁ and f₂ are two possible focal lengths for the lens 114. In this regard, the lens 114 with the focal length of f₁ may focus or project the point Q(x,y) in the XY-plane 201 to the point P₁(x,y,z₁) in the image plane 202. The lens 114 with the focal length of f₂ may focus or project the point Q(x,y) in the XY-plane 201 to the point P₂(x,y,z₂) in the image plane 202. The distance, d₁, between the object point P₁(x,y,z₁) and the point Q(x,y,0) may reflect corresponding depth information for the object point P₁(x,y,z₁) with respect to the point Q(x,y,0). The distance, d₂, between the object point P₂(x,y,z₂) and the point Q(x,y,0) in the XY-plane 201 may reflect corresponding depth information for the object point P₂(x,y,z₂) with respect to the point Q(x,y,0). In addition, the coordinate for the object point P₁(x,y,z₁) and the object point P₂(x,y,z₂) may be calculated from image coordinate to Euclidean coordinate as:

$${P}_{1} ( \begin{matrix}X \\ Y \\ Z\end{matrix} ) = s + d = ( \begin{matrix}x \\ y \\ 0\end{matrix} ) + ( \begin{matrix}- x \\ - y \\ {f}_{1}\end{matrix} ) \frac{{d}_{1}}{\sqrt{{x}^{2} + {y}^{2} + {f}_{1}^{2}} } and$$

$${P}_{2} ( \begin{matrix}X \\ Y \\ Z\end{matrix} ) = s + d = ( \begin{matrix}x \\ y \\ 0\end{matrix} ) + ( \begin{matrix}- x \\ - y \\ {f}_{2}\end{matrix} ) \frac{{d}_{2}}{\sqrt{{x}^{2} + {y}^{2} + {f}_{2}^{2}}} ,$$

where d₁ and d₂ are the distance from the point Q(x,y,0) to the actual object points in space, P₁(x,y,z₁) and P₂(x,y,z₂), respectively, and f₁ and f₂ are two focal lengths for the lens 114. In this regard, the same point Q(x,y,0) may be projected or focused farther with an increased focal length for the lens 114, Accordingly, the corresponding depth information for the objects in the target scene may be utilized to adjust the focal length of the lens 114 to focus the monoscopic video camera 110₁ to the objects in the target scene.

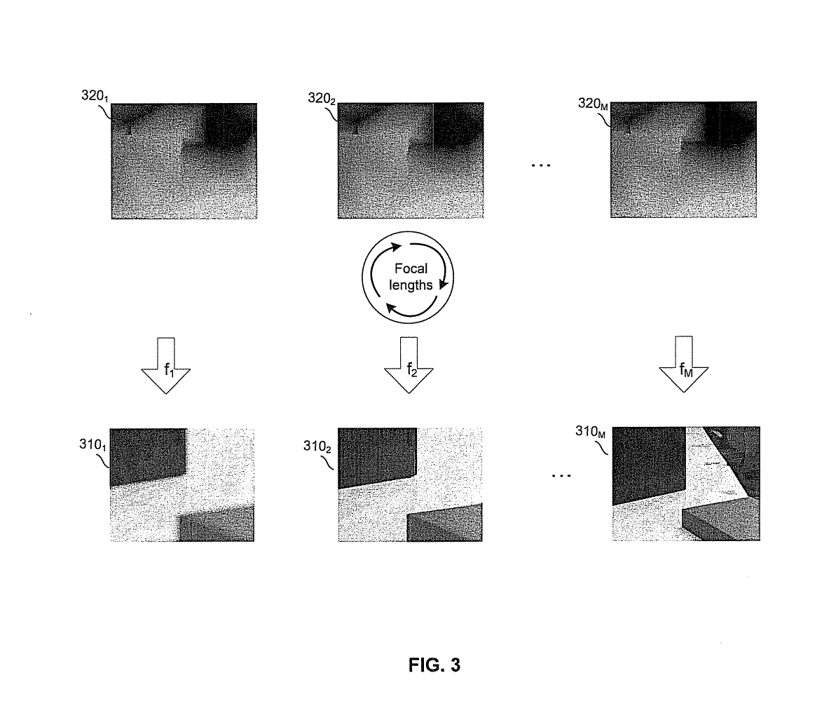

FIG. 3 illustrates auto-focusing of 2D monoscopic images utilizing corresponding depth information, in accordance with an embodiment of the invention. Referring to FIG. 3, there is shown a plurality of 2D monoscopic images 310₁-310_{M} and a plurality of depth images 320₁-320_{M} that may be captured via the monoscopic video camera 110₁, where the parameter M is an integer and M>0. The captured depth images 320₁-320_{M} comprise corresponding depth information for the captured 2D monoscopic images 310₁-310_{M}. The parameters f₁ . . . f_{M} represent possible focal lengths for the lens 114 to capture the 2D monoscopic images 310₁-310_{M} and the corresponding depth images 320₁-320_{M}, respectively. In this regard, the focal lengths f₁ . . . f_{M} may be selected based on the captured corresponding depth images 320₁-320_{M}. For example, the monoscopic video camera 110₁ may be operable to perform auto-focusing starting with the 2D monoscopic image 310₁ and the corresponding depth images 320₁. The depth images 320₁ may reflect or indicate information related to the focal length f₁ for the lens 114. In this regard, the monoscopic video camera 110₁ may select the focal length f₁ based on depth values of the depth images 320₁ and associated lighting condition changes to focus the captured 2D monoscopic images 310₁. The process may be repeated or continued for the sharpest possible image such as the 2D monoscopic image 310_{M}.

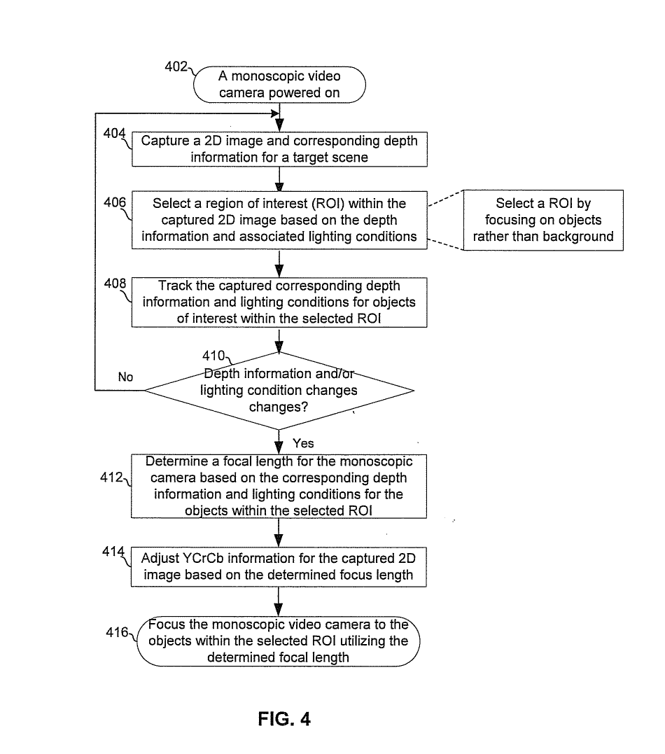

FIG. 4 is a flow chart illustrating exemplary steps that may be performed for auto-focusing in a monoscopic video camera utilizing depth information, in accordance with an embodiment of the invention. Referring to FIG. 4, the exemplary steps may begin with step 402, in which a monoscopic video camera such as the monoscopic video camera 110₁ is powered on. In step 404, the monoscopic video camera 110₁ may be operable to capture a 2D monoscopic image for a target scene. In step 406, the monoscopic video camera 110₁ may be operable to select a region of interest (ROI) within the captured 2D monoscopic image. In this regard, the ROI selection may be focused on image data on objects, rather than background image data. For example, background areas may be simply blurred within selected ROI. In step 408, the monoscopic video camera 110₁ may be operable to track or monitor the captured depth information and lighting conditions corresponding to objects of interest within the selected ROI. In step 410, it may be determined whether the captured corresponding depth information and associated lighting conditions for the objects within the selected ROI changes. In instances where the captured corresponding depth information and the associated lighting conditions for the objects within the selected ROI changes, then in step 412, a focal length may be determined or selected for the lens 114 based on the captured corresponding depth information and the associated lighting conditions for the objects within the selected ROI. In step 414, the luminance, chrominance red and chrominance blue (YCrCb) information for the captured 2D image may be determined and/or adjusted based on the determined focal length for the lens 114. For example, the YCrCb information may be enhanced for the captured 2D monoscopic image with an increased focal length for the lens 114. In step 416, the lens 114 may focus the monoscopic video camera 110₁ to the objects within the selected ROI utilizing the determined focal length for the lens 114.

In step 410, in instances where the captured corresponding depth information and the associated lighting conditions for the objects within the selected ROI does not change, then the exemplary steps may return to step 404.

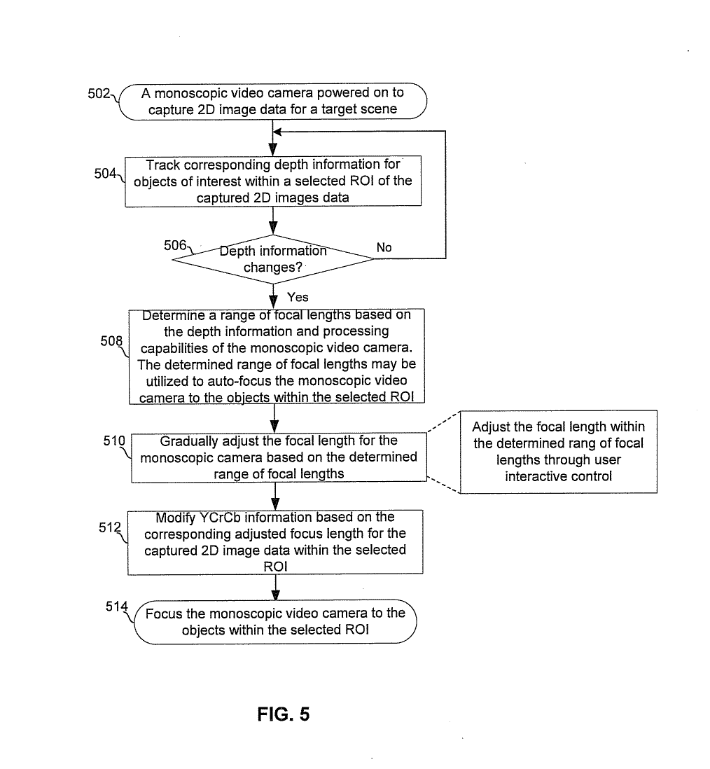

FIG. 5 is a flow chart illustrating exemplary steps that may be performed for multi-step auto-focusing in a monoscopic video camera utilizing depth information, in accordance with an embodiment of the invention. Referring to FIG. 5, the exemplary steps may begin with step 502, in which a monoscopic video camera such as the monoscopic video camera 110₁ is powered on to capture a 2D image for a target scene. In step 504, the monoscopic video camera 110₁ may be operable to track corresponding depth information for objects of interest within a selected ROI of the captured 2D monoscopic image. In step 506, it may be determined whether the corresponding depth information for the objects within the selected ROI changes. In instances where the corresponding depth information for the objects within the selected ROI changes, then in step 508, a range of focal lengths may be determined based on the depth information, associated lighting conditions and processing capabilities of the monoscopic video camera 110₁. The determined range of focal lengths may be utilized to auto-focus the monoscopic video camera 110₁ to the objects within the selected ROI.

In step 510, the monoscopic video camera 110₁ may be operable to gradually adjust, in multi-steps, the focal length for the lens 114 of the monoscopic video camera 110₁ based on the determined range of focal lengths. In this regard, the monoscopic video camera 110₁ select or determine a focal length step size for multi-step auto-focusing based on the processing capabilities of the monoscopic video camera 110₁ and/or the mobility state of the objects in the target scene. For example, for fast moving objects within the selected ROI, the focal length step size may be decreased so as to track the objects for the sharpest possible images. In an exemplary embodiment of the invention, the monoscopic video camera 110₁ may be operable to interact with users so as to control and/or adjust the focal length step size. In other words, the monoscopic video camera 110₁ may control and/or adjust the focal length step size through user interactive control in order to meet user's preferences.

In step 512, the monoscopic video camera 110₁ may be operable to modify or set the YCrCb information for the captured 2D images based on the corresponding adjusted focal length for the lens 114 of the monoscopic video camera 110₁. In step 514, the monoscopic video camera 110₁ may be operable to focus to the objects within the selected ROI utilizing the adjusted focal length.

Various aspects of a method and system for depth-information based auto-focusing for a monoscopic video camera are provided. In various exemplary embodiments of the invention, the monoscopic video camera array 110 comprises one or more image sensors and one or more depth sensors. Each associated monoscopic video camera such as the monoscopic video camera 110₁ of the monoscopic video camera array 110 may be operable to concurrently collect or capture a 2D monoscopic image and corresponding depth information. A region of interest within the captured 2D monoscopic image may be selected as a focal point based on the captured corresponding depth information and associated lighting conditions for focusing the captured 2D monoscopic image. In other words, the monoscopic video camera 110₁ may automatically focus the captured 2D monoscopic image utilizing the captured corresponding depth information and the associated lighting conditions within the selected region of interest. In this regard, the focal length for the lens 114 may be selected based on the captured corresponding depth information and the associated lighting conditions within the selected region of interest, and/or user inputs. Luminance, chrominance red and chrominance blue (YCrCb) information for the captured two-dimensional image may be adjusted based on the selected focal length.

The monoscopic video camera 110₁ may adjust focus of the captured 2D monoscopic image together with the adjusted YCrCb information for display. Depending on system configuration, auto-focusing may be performed in multi-steps. In this regard, a range of focal lengths for the lens 114 of the monoscopic video camera 110₁ may be determined based on the captured corresponding depth information and the associated lighting conditions within the selected region of interest and/or processing capabilities such as motion detection of the monoscopic video camera 110₁. A step size for auto-focusing may be selected or determined based on the determined range of focal lengths for the lens 114, the processing capabilities of the monoscopic video camera 110₁, a mobility state of one or more objects within the selected region of interest. The step size for auto-focusing may be also selected within the determined range of focal lengths for the lens 114 through interacting with users. The focal length may be selected for the lens 114 based on the selected step size. The YCrCb information for the captured two-dimensional image may be adjusted, accordingly, based on the selected focal length. Depending on actual image quality, the selected focal length may be adjusted, for example, increasing or decreasing the selected focal length by the selected step size. The auto-focusing process may be repeated per step for a high quality focused image.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for depth-information based auto-focusing for a monoscopic video camera.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
in or in connection with a monoscopic video camera array comprising one or more image sensors and one or more depth sensors:
concurrently capturing a two-dimensional image and corresponding depth information; and
selecting based on said corresponding depth information and associated lighting conditions, a region of interest within said captured two-dimensional image as a focal point for focusing said captured two-dimensional image.

2. The method of claim 1, comprising selecting a focal length for said monoscopic video camera array based on said captured corresponding depth information and said associated lighting conditions within said selected region of interest, and/or user inputs.

3. The method of claim 2, comprising adjusting luminance, chrominance red and chrominance blue (YCrCb) information for said captured two-dimensional image based on said selected focal length.

4. The method of claim 3, comprising adjusting focus of said captured two-dimensional image with said adjusted YCrCb information utilizing said selected focal length.

5. The method according to claim 2, comprising determining a range of focal lengths for said selecting of said focal length based on said captured corresponding depth information and said associated lighting conditions within said selected region of interest and/or processing capabilities of said monoscopic video camera array.

6. The method according to claim 5, comprising selecting a step size based on said determined range of focal lengths, said processing capabilities, a mobility state of one or more objects within said selected region of interest, and/or user inputs.

7. The method according to claim 6, comprising selecting said focal length for said monoscopic video camera array based on said selected step size.

8. The method according to claim 7, comprising:
adjusting luminance, chrominance red and chrominance blue (YCrCb) information for said captured two-dimensional image based on said selected focal length; and
adjusting focus of said captured two-dimensional image with said adjusted YCrCb information utilizing said selected focal length.

9. The method according to claim 8, comprising adjusting said selected focal length based on said determined step size.

10. The method according to claim 9, comprising:
adjusting luminance, chrominance red and chrominance blue (YCrCb) information for said captured two-dimensional image based on said adjusted focal length; and
adusting focus of said captured two-dimensional image with said adjusted YCrCb information utilizing said adjusted focal length.

11. A system for processing signals, the system comprising:
one or more processors and/or circuits for use in or in connection with a monoscopic video camera array comprising one or more image sensors and one or more depth sensors, wherein said one or more processors and/or circuits are operable to:
concurrently capture a two-dimensional image and corresponding depth information; and
select based on said corresponding depth information and associated lighting conditions, a region of interest within said captured two-dimensional image as a focal point for focusing said captured two-dimensional image.

12. The system according to claim 11, wherein said one or more circuits are operable to select a focal length for said monoscopic video camera array based on said captured corresponding depth information and said associated lighting conditions within said selected region of interest, and/or user inputs.

13. The system according to claim 12, wherein said one or more circuits are operable to adjust luminance, chrominance red, and chrominance blue (YCrCb) information for said captured two-dimensional image based on said selected focal length.

14. The system according to claim 13, wherein said one or more circuits are operable to adjust focus of said captured two-dimensional image with said adjusted YCrCb information utilizing said selected focal length.

15. The system according to claim 12, wherein said one or more circuits are operable to determine a range of focal lengths for said selecting of said focal length based on said captured corresponding depth information and said associated lighting conditions within said selected region of interest and/or processing capabilities of said monoscopic video camera array.

16. The system according to claim 15, wherein said one or more circuits are operable to select a step size based on said determined range of focal lengths, said processing capabilities, a mobility state of one or more objects within said selected region of interest, and/or user inputs.

17. The system according to claim 16, wherein said one or more circuits are operable to select said focal length for said monoscopic video camera array based on said selected step size.

18. The system according to claim 17, wherein said one or more circuits are operable to adjust luminance, chrominance red and chrominance blue (YCrCb) information for said captured two-dimensional image based on said selected focal length; and said one or more circuits are operable to adjust focus of said captured two-dimensional image with said adjusted YCrCb information utilizing said selected focal length.

19. The system according to claim 18, wherein said one or more circuits are operable to adjust said selected focal length based on said determined step size.

20. The system according to claim 19, wherein said one or more circuits are operable to adjust luminance, chrominance red and chrominance blue (YCrCb) information for said captured two-dimensional image based on said increased focal length; and said one or more circuits are operable to adjust focus of said captured two-dimensional image with said adjusted YCrCb information utilizing said adjusted focal length.
